(19) United States
(12) Patent Application Publication
(10) Pub. No.: US 2020/0391256 A1
(43) Pub. Date: Dec. 17, 2020

(54) JETTER NOZZLE ASSEMBLY

(71) Applicant: Paul DEL PIERO, Sunrise Beach, TX (US)

(72) Inventor: Paul DEL PIERO, Sunrise Beach, TX (US)

(21) Appl. No.: 16/440,445

(22) Filed: Jun. 13, 2019

(51) Int. Cl. B08B 9/043

(52) U.S. Cl. CPC B08B 9/0433

(57) ABSTRACT

A jetter nozzle has a body with the shape of a prolate spheroid. The body has an internal bore opening at one end thereof. The bore is adapted to receive an end of a hose therein. The body has an internal shoulder in the bore. A plurality of orifices communicate with the bore and open at an exterior of the body. An internal seal is juxtaposed against the shoulder such that a coupling of a hose can be compressed in sealing relation against.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates generally to apparatus for removing obstructions from sewers, drains and pipes. More particularly, the present invention relates to jetter nozzles that emit a strong stream of a fluid for the purposes of removing obstructions.

### 2. Description of Related Art Including Information Disclosed Under 37 CFR 1.97 and 37 CFR 1.98

Prior methods for removing build-up or obstructions from sewers, pipes and drain lines include the use of chemicals, mechanical cutters, and jetter nozzles. A jetter nozzle is connected to a hose and a water supply. The jetter nozzle advances forwardly in a sewer line or pipe by spraying jets of water rearwardly and radially outwardly at an angle from horizontal. A jetter nozzle typically provides for a single forwardly directed stream of water. However, the bulk of the cleaning action is limited to along the walls of the pipe or sewer line rearwardly of the nozzle. The cleaning results from the rearwardly directed streams of water impinging on the pipe or sewer wall. Although the forwardly-directed stream is capable of eroding a hole through certain materials, such nozzles have difficulty impinging the sewer wall. Jetter nozzles are typically used for removing build-up that is relatively soft, such as grease or organic waste.

In the past, jetter nozzles have been known which have inadequate performance. In these prior art jetter nozzles, the outside shape of the nozzle inhibits the ability to corner in rough and small diameter pipe elbows. The back jets typically have an angle of greater than 25 degrees. As such, it provides less pulling force while being directed through the pipe or sewer. These prior art jetter nozzles have an excessive length which is caused by a poor matching of thread depths, the depth of the internal seating surface, and the washer thickness. This inhibits cornering in short radius elbows. Additionally, the selection of nozzle orifice size is not optimized for use with consumer pressure washers.

In the past, various patents have issued with respect to such jetter nozzles. For example, U.S. Pat. No. 3,165,109, issued on Jan. 12, 1965 to P. Hammelmann, describes an apparatus for the cleaning of sewer systems. This apparatus includes a hose, a nozzle carried by the end of the hose, and a means connected to the hose for supplying cleaning fluid thereto under pressure. A guiding means guides the hose for insertion into a sewer pipe. A cable is attached to the hose adjacent to the nozzle and is guided by the guiding means.

U.S. Pat. No. 3,535,161, issued on Oct. 20, 1970 to R. J. Gutrich, teaches a process and apparatus for clearing sewer lines and the like by application of water at normal household pressures through flexible tubing to a jet-creating head that is connected to the end of the tubing. The jet-creating head is inserted into and passed through the line by means of the tubing. There is a first axial jet head for opening up a passage through the line and a second tangential or swirl jet head for thoroughly cleaning the line.

U.S. Pat. No. 4,322,868, issued on Apr. 6, 1982 to J. C. Wrster, describes a sewer and catch basin cleaner that includes a system for injecting water under pressure into a sewer for cleaning the sewer and a vacuum loading system for removing water and debris from the sewer catch basin. The cleaner includes a water storage tank for providing the cleaning water and a body for receiving the material removed from the catch basin or manhole.

U.S. Pat. No. 5,988,188, issued on Nov. 23, 1999 to J. C. Born, provides a method and apparatus for removing obstruction from sewers without cutters or chemicals. A forwardly-thrusting nozzle is adapted to spray jets of high-pressure, high-temperature water or steam. The nozzle is connected to a hose. The nozzle and hose are inserted through adapter fittings to exit from the outlet opening into a leg of the sewer having the obstruction. A hot water/steam supply connected to the upstream end of the hose provides a supply of steam or hot, pressurized water to the nozzle. The nozzle is advanced through the sewer line to remove the build-up from the sewer walls with the aid of the jets of water.

U.S. Patent Application Publication No. 2016/0089703, issued on Mar. 31, 2016 to the present inventor, describes a sewer jetter apparatus. The sewer jetter apparatus includes a sewer jetter attachment and a sewer jetter hose. A coating is provided over a joint formed by the sewer jetter attachment and the sewer jetter hose. The coating provides a smooth sloped transition between the sewer jetter attachment and the sewer jetter hose. The coating enables improved performance of the sewer jetter apparatus during retraction of the apparatus from a pipe.

It is an object of the present invention provide a jetter nozzle that has improved performance.

It is another object of the present invention to provide a jetter nozzle that can travel further in the drain, pipe or sewer.

It is another object of the present invention to provide a jetter nozzle that can pass through various sizes of elbows and traps.

It is another object of the present invention to provide a jetter nozzle that has an improved seal and has reduced leakage.

It is still another object of the present invention to provide a jetter nozzle that has a greater pulling force.

It is another object of the present invention to provide a jetter nozzle that has improved cornering ability in rough and small diameter pipe elbows.

It is still another object of the present invention provide a jetter nozzle that is adapted to consumer pressure washers.

These and other objects and advantages of the present invention will become apparent from a reading of the attached specification and appended claims.

### BRIEF SUMMARY OF THE INVENTION

The present invention is a jetter nozzle that comprises a body having a shape of a prolate ellipsoid. The body has an internal bore opening at one end thereof. The bore is adapted to receive an end of the hose therein. The body has an internal shoulder in the internal bore. A plurality of orifices communicate with the bore and open at the exterior of the body. An internal seal is juxtaposed against the shoulder.

The internal bore has a first portion extending from the shoulder to the end of the body and a second portion extending from the shoulder toward an opposite end of the body. The first portion of the internal bore has a diameter greater than a diameter of the second portion of the internal bore. At least some of the plurality of orifices have a first end opening to the second portion of the internal bore and a second end opening to the exterior of the body rearwardly of the first end. Each of the plurality of orifices extends at an approximately 25 degree angle with respect to the longitudinal axis of the body. The body has a planar surface of an opposite end of the body. One of the plurality of orifices open at the planar surface.

The exterior of the body has wide diameter portion and a narrow diameter portion rearwardly of the wide diameter portion. At least some of the plurality of orifices open at the narrow diameter portion. The plurality of orifices comprises three orifices circumferentially spaced approximately 120 degrees from each other or four orifices circumferentially spaced ninety degrees from each other. One of the plurality of orifices can open at an opposite end of the body.

The internal seal is of a thermoplastic material, such as polyetra fluoroethylene, polyethylene terephthalate, nylon or similar materials. The first portion of the internal bore is internally threaded.

The present invention is also a jetter assembly that comprises that a body having a shape of a prolate ellipsoid, an internal seal juxtaposed against a shoulder within an internal bore of the body, and a hose having a coupling at one end thereof. The coupling is received in the internal bore and is in compressive bearing relationship against the internal seal. The internal bore opens at one end of the body. The body has a plurality of orifices communicating with the bore and opening at the exterior of the body. The internal bore is internally threaded. The coupling of the hose has an external threads engaged with the internal threads of the internal bore.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a perspective view showing the operation of the jetter nozzle assembly of the present invention.

FIG. 2 is a perspective exploded view showing the jetter nozzle assembly of the present invention.

FIG. 3 is a cross-sectional view showing the jetter nozzle of the present invention.

FIG. 4 is a rear end view of the jetter nozzle of the present invention.

### DETAILED DESCRIPTION OF THE INVENTION

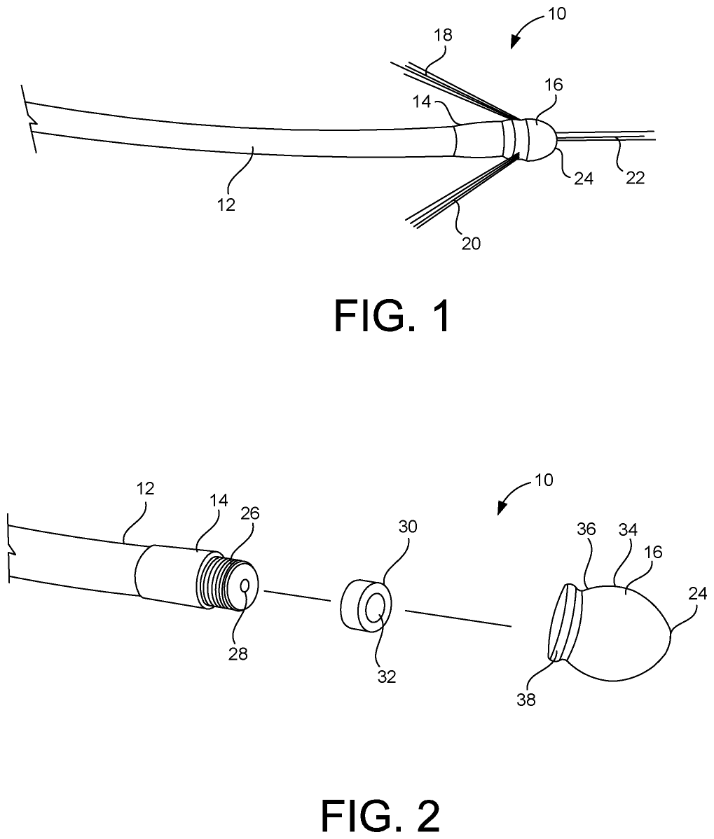

Referring to FIG. 1, there is shown the jetter nozzle assembly 10 in accordance with the present invention. The jetter nozzle assembly 10 includes a hose 12 that has a coupling 14 at one end thereof. The hose 12 is adapted to be connected to a supply of pressurized water (or other fluid). In particular, the hose 12 will have a coupling at an opposite end thereof which allows the hose 12 to be connected to a pump or other source of pressurized water. The coupling 14 of hose 12 is engaged with jetter nozzle 16. In particular, in the present invention, the coupling 14 will have external threads at an end thereof which engage the internal threads on the internal bore of the jetter nozzle 16.

FIG. 1 shows that the jetter nozzle 16 has a prolate spheroid shape. This prolate spheroid shape allows the jetter nozzle 16 to better penetrate through material within a pipe, sewer or drain. Additionally, it has been found, after experimentation, that the prolate ellipsoid shape of the jetter nozzle 16 facilitates the ability of the jetter nozzle 16 to travel further within the drain, pipe or sewer. This shape allows the jetter nozzle to pass through various sizes of elbows and traps. This prolate ellipsoid shape further facilitates the ability of the jetter nozzle 16 to have improved cornering ability in rough and small diameter pipe elbows. Unlike prior jetter nozzle assemblies, the present invention is particularly adapted for use by consumers and for use with household pressure washers.

FIG. 1 shows that there is a first jet of fluid 18, a second jet of fluid 20 and a third jet of fluid 22. The jets 18 and 20 are directed rearwardly at an approximately twenty-five degree angle with respect to a longitudinal axis of the jetter nozzle 16. This twenty-five degree angle is optimized so as to create greater pulling force by the jetter nozzle 16 within the drain, pipe or sewer. This twenty-five degree angle has also been found to create a greater shearing force with respect to any debris that may be on the wall of the pipe, drain or sewer. As such, the pressurized release of fluids through orifices (described hereinafter) from the jetter nozzle 16 greatly improves the ability of the jetter nozzle 16 to travel within the pipe and to better clean the surfaces of the pipe. It is important to note that there will be three or four streams of fluid that are directed rearwardly from the jetter nozzle 16. Since the three orifices will be spaced circumferentially 120° from each other or four orifices spaced circumferentially 90° from each other, the third and/or fourth streams of water would be obscured from view in FIG. 1 by the hose or by the streams of water 18 and 20.

The stream of fluid 22 is projected from the forward end 24 of the jetter nozzle 16. This forward jet of fluid 22 is intended to removed soft obstructions that lie in front of the moving jetter nozzle 16. Although the stream of fluid 22 can facilitate the ability to better move the jetter nozzle 16 within the pipe, it is been found that the jetter nozzle assembly 10 can operate efficiently and effectively without the forwardly-projecting fluid stream 22. The jetter nozzle 16 is moved forwardly within the drain, pipe or sewer by the force of the fluid streams 18 and 20 and by moving the hose 12 forwardly.

FIG. 2 is an exploded view showing the jetter nozzle assembly 10 of the present invention. As can be seen in FIG. 2, the hose 12 has coupling 14 with external threads 26. A fluid passageway 28 opens at the end of the coupling 10 and is of a reduced diameter so that fluid flows outwardly of the fluid passageway 18 with great force. An internal seal 30 is illustrated as being of a generally annular shape. This internal seal 20 can be in the nature of a washer. Internal seal 30 works as a compression seal when the jetter nozzle 16 is threaded onto the external threads 26 of the coupling 14. The internal seal 30 can be formed of a thermoplastic material, such as polytetrafluoroethylene, polyethylene terephthalate, nylon, TEFLON™, or similar materials. The internal seal 30 will have an opening 32 formed centrally thereof. Fluid can flow through this opening 32.

FIG. 2 shows that the jetter nozzle 16 has a prolate ellipsoid shape. The forward end 24 is generally flattened. The jetter nozzle 16 has a wide diameter portion 34 and a narrow diameter portion 36. As will be described hereinafter, the orifices will open at this narrow diameter portion 36. A widened end portion 38 is located at the rearward portion of the jetter nozzle 16.

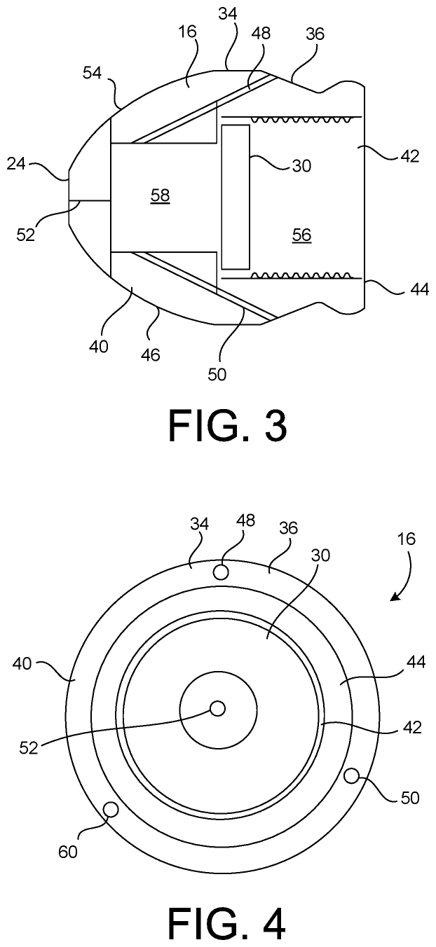

FIG. 3 shows a cross-sectional view of the jetter nozzle 16. The jetter nozzle 16 has a body 40 with the prolate ellipsoid shape. The body 40 has an internal bore 42 that opens at end 44 of body 40. It can be seen that the internal bore 42 is adapted to receive an end of a coupling or hose therein. The body 40 has an internal shoulder 46 within the internal bore 40. The body is illustrated in FIG. 3 as having orifices 48, 50 and 52 formed therethrough. Each of the orifices 48, 50 and 52 has one end communicating with the internal bore 42 and an opposite end opening at the exterior surface 54 of the body 40. The internal seal 30 is juxtaposed against the interior shoulder 46.

The internal bore 42 has a first portion 56 and a second portion 58. The first portion 56 extends from the shoulder 46 to the end 44 of the body 40. The second portion 58 extends from the shoulder 46 toward the opposite end 24 of the body 40. The first portion 56 has a diameter greater than a diameter of the second portion 58.

In FIG. 3, it can be seen that orifices 48 and 50 have a first end opening to the second portion 58 of the internal bore 42. Each of the orifices 48 and 50 also open to the exterior 54 of the body 40 rearwardly of the second portion 58 of the internal bore 42. In one embodiment, orifices 48 and 50 are circumferentially spaced by 120° from each other. In another embodiment, there are four streams of water spaced circumferentially 90° from each other. Each of the orifices 48 and 50 (along with the orifice(s) that were not shown) extends at an approximately twenty-five degree angle with respect to the longitudinal axis of the body 40.

FIG. 3 shows that the end 24 of the body 40 has a generally planar surface. In one embodiment, the orifice 52 has one end opening to the second portion 58 of the internal bore 42 and an opposite end opening at the end 24 of the body 40.

The body 40 has the wide diameter portion 34 and a narrow diameter portion 36. Each of the orifices 48 and 50 open at the narrow diameter portion 36. When a fluid, such as water, is introduced under pressure into the internal bore 48, it will flow through the opening 32 of the internal seal 30 and into the second portion 58. The water will then be ejected, under pressure, from the second portion 58 of the internal bore 42 and outwardly through the orifices 48, 50 and 52. The fluid passing outwardly of the orifices 48 and 50 creates a strong pulling and shearing force. The fluid that is ejected through the orifice 52 is intended to remove obstructions. Within the concept of the present invention, it is possible to omit orifice 52. The removal of orifice 52 will increase the pressure passing through the orifices 48 and 50 (along with the orifice that is not shown). As such, there is a greater pulling and shearing force emitted by these orifices. The omission of orifice 52 would avoid a counter force (caused by the forwardly projecting fluid) to the pressure from the orifices 48 and 50.

FIG. 4 is an end view of the jetter nozzle 16 of the present invention. The end 44 of the jetter nozzle 16 has an annular shape. The internal seal 30 is shown as located within the internal bore 42. The wide diameter portion 34 is shown with the narrow diameter portion 36 extending therefrom. Importantly, orifices 48, 50 and 60 are shown on this narrow diameter surface 36. Orifices 48, 50 and 60 are spaced circumferentially by about 120° from each other. The orifice 52 is illustrated as longitudinally aligned with the longitudinal axis of the body 40.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A jetter nozzle comprising:
a body having a shape of a prolate ellipsoid, said body having an internal bore opening at one end of said body, said internal bore adapted to receive an end of a hose therein, said body having an internal shoulder in said internal bore, said body having a plurality of orifices communicating with said bore and opening at an exterior of said body; and
an internal seal juxtaposed against said internal shoulder.

2. The jetter nozzle of claim 1, said internal bore having a first portion extending from said shoulder to the end of said body and a second portion extending from said shoulder toward an opposite end of said body.

3. The jetter nozzle of claim 2, said first portion of said internal bore having a diameter greater than a diameter of the second portion of said internal bore.

4. The jetter nozzle of claim 3, at least some of said plurality of orifices having a first end opening to the second portion of said internal bore and a second end opening at the exterior of said body rearwardly of the first end.

5. The jetter nozzle claim 4, each of the at least some of said plurality of orifices extending at an approximately twenty-five degree angle with respect to a longitudinal axis of said body.

6. The jetter nozzle of claim 1, said body having a planar surface at an opposite end of said body, one of said plurality of orifices opening at the planar surface.

7. The jetter nozzle claim 1, the exterior of said body having a wide diameter portion and a narrow diameter portion rearwardly of the wide diameter portion, at least some of said plurality of orifices open at the narrow diameter portion.

8. The jetter nozzle of claim 1, said plurality of orifices comprising three fluid passageways circumferentially spaced approximately 120° from each other or four fluid passageway circumferentially spaced approximately 90° from each other.

9. The jetter nozzle claim 1, one of said plurality of orifices opening at an opposite end of said body.

10. The jetter nozzle of claim 1, said internal seal being of a thermoplastic material.

11. The jetter nozzle of claim 2, said first portion of said internal bore being internally threaded.

12. A jetter nozzle comprising:
a body a body having an internal bore opening at one end of said body, said internal bore adapted receive an end of a hose therein, said body having an internal shoulder in said internal bore, said body having a plurality of orifices communicating with said bore and opening at an exterior said body, said interior bore having a first portion extending from said shoulder to the end of said body and a second portion extending from said shoulder toward an opposite end of said body, said first portion of said internal bore having a diameter greater than a diameter of the second portion of said internal bore, at least some of said plurality of orifices having a first end opening to the second portion of said internal bore and a second end opening at the exterior of said body rearwardly of the first end; and
an internal seal juxtaposed against said shoulder.

13. The jetter nozzle of claim 12, each of the at least some of said plurality of orifices extending an approximately twenty-five degree angle with respect to the longitudinal axis of said body.

14. The jetter nozzle of claim 13, said plurality of orifices comprising three orifices circumferentially spaced from each other by approximately 120° or four orifics circumferentially spaced approximately 90° from each other.

15. The jetter nozzle of claim 12, one of said plurality of orifices opening at an opposite end of said body.

16. The jetter nozzle of claim 12, said body having a shape of a prolate ellipsoid.

17. A jetter assembly comprising:
a nozzle having a body with the shape of a prolate ellipsoid, said body having an internal bore opening at one end of said body, said body having an internal shoulder in said internal bore, said body having a plurality of orifices communicating with said bore and opening at an exterior of said body;
an internal seal juxtaposed against said shoulder; and
a hose having a coupling at one end thereof, said coupling received in said internal bore and compressively a bearing against said internal seal.

18. The jetter assembly of claim 17, said internal bore having a first portion extending from said shoulder to the end of said body and a second portion extending from said shoulder toward an opposite end of said body, said first portion of said internal bore having a diameter greater than a diameter of said second portion of said internal bore, at least some of said plurality of orifices having a first end opening to the second portion of said internal bore and a second end opening at the exterior of said body rearwardly of the first end.

19. The jetter assembly of claim 18, each of the at least some of said plurality of orifices extending at an approximately twenty-five degree angle with respect to the longitudinal axis of said body, the at least some of said plurality of orifices comprising three orifices circumferentially spaced by approximately 120° from each other, or four orifices circumferentially spaced by approximately 90° from each other, one of said plurality of orifices opening at an opposite end of said body and aligned with the longitudinal axis of said body.

20. The jetter assembly of claim 17, said internal bore being internally threaded, said hose having external threads engaged with the internal threads of said internal bore.
